(19) United States
(12) Patent Application Publication
(10) Pub. No.: US 2014/0181402 A1
(43) Pub. Date: Jun. 26, 2014

(54) SELECTIVE CACHE MEMORY WRITE-BACK AND REPLACEMENT POLICIES

(71) Applicant: ADVANCED MICRO DEVICES, INC., Sunnyvale, CA (US)

(72) Inventor: Sean T. WHITE, Westborough, MA (US)

(73) Assignee: Advanced Micro Devices, Inc., Sunnyvale, CA (US)

(21) Appl. No.: 13/724,343

(22) Filed: Dec. 21, 2012

(51) Int. Cl. G06F 12/08

(52) U.S. Cl. CPC G06F 12/0802
USPC 711/122

(57) ABSTRACT

A method of managing cache memory includes assigning a caching priority designator to an address that addresses information stored in a memory system. The information is stored in a cacheline of a first level of cache memory in the memory system. The cacheline is evicted from the first level of cache memory. A second level in the memory system to which to write back the information is determined based at least in part on the caching priority designator. The information is written back to the second level.

### TECHNICAL FIELD

The present embodiments relate generally to cache memory, and more specifically to cache memory policies.

### BACKGROUND

A software application—for example, a cloud-based server software application—may include information (e.g., instructions and/or a first portion of data) that is commonly referenced by the processor core or cores executing the application and information (e.g., a second portion of data) that is infrequently referenced by the processor core or cores. Caching information that is infrequently referenced in cache memory will result in high cache miss rates and may pollute the cache memory by forcing eviction of information that is commonly referenced.

### SUMMARY

Embodiments are disclosed in which cache memory management policies are selected based on caching priorities that may differ for different addresses.

In some embodiments, a method of managing cache memory includes assigning a caching priority designator to an address that addresses information stored in a memory system. The information is stored in a cacheline of a first level of cache memory in the memory system. The cacheline is evicted from the first level of cache memory. A second level in the memory system to which to write back the information is determined based at least in part on the caching priority designator. The information is written back to the second level.

In some embodiments, a circuit includes multiple levels of cache memory and an interconnect to couple to a main memory. The multiple levels of cache memory include a first level of cache memory. The main memory and the multiple levels of cache memory are to compose a plurality of levels of a memory system. The circuit also includes a cache controller to evict a cacheline from the first level of cache memory and to determine a second level of the plurality of levels to which to write back information stored in the evicted cacheline based at least in part on a caching priority designator assigned to an address of the information.

In some embodiments, a non-transitory computer-readable storage medium stores instructions, which when executed by one or more processor cores, cause the one or more processor cores to assign a caching priority designator to an address that addresses information stored in memory. A first level of cache memory, when evicting a cacheline storing the information, is to determine a second level of memory to which to write back the information based at least in part on the caching priority designator.

### BRIEF DESCRIPTION OF THE DRAWINGS

The present embodiments are illustrated by way of example and are not intended to be limited by the figures of the accompanying drawings.

FIG. 1 is a block diagram showing a memory system 100 in accordance with some embodiments.

FIG. 2A is a block diagram showing address translation coupled to a cache memory and configured to assign caching priority designators to addresses in accordance with some embodiments.

FIG. 2B is a block diagram showing address translation and a memory-type range register (MTRR) coupled to a cache memory, wherein the MTRR is configured to assign caching priority designators to ranges of addresses in accordance with some embodiments.

FIG. 3A shows a data structure for the address translation of FIG. 2A in accordance with some embodiments.

FIG. 3B shows a data structure for the MTRR of FIG. 2B in accordance with some embodiments.

FIG. 4 is a block diagram of a cache memory and associated cache controller in accordance with some embodiments.

FIG. 5 illustrates a data structure for a second-chance use table used to implement a second-chance replacement policy modified based on caching priority designators in accordance with some embodiments.

FIGS. 6A and 6B are flowcharts showing methods of managing cache memory in accordance with some embodiments.

Like reference numerals refer to corresponding parts throughout the figures and specification.

### DETAILED DESCRIPTION

Reference will now be made in detail to various embodiments, examples of which are illustrated in the accompanying drawings. In the following detailed description, numerous specific details are set forth in order to provide a thorough understanding of the disclosure. However, some embodiments may be practiced without these specific details. In other instances, well-known methods, procedures, components, and circuits have not been described in detail so as not to unnecessarily obscure aspects of the embodiments.

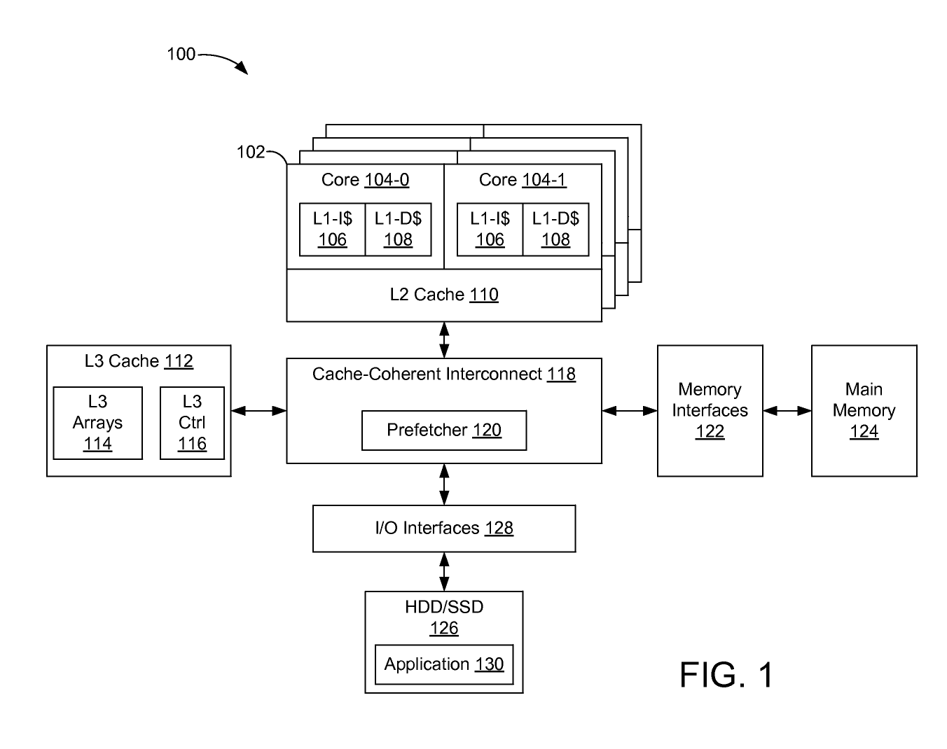

FIG. 1 is a block diagram showing a memory system 100 in accordance with some embodiments. The memory system 100 includes a plurality of processing modules 102 (e.g., four processing modules 102), each of which includes a first processor core 104-0 and a second processor core 104-1. Each of the processor cores 104-0 and 104-1 includes a level 1 instruction cache memory (L1-I$) 106 to cache instructions to be executed by the corresponding processor core 104-0 or 104-1 and a level 1 data cache (L1-D$) memory 108 to store data to be referenced by the corresponding processor core 104-0 or 104-1 when executing instructions. (The term data as used herein does not include instructions unless otherwise noted.) A level 2 (L2) cache memory 110 is shared between the two processor cores 104-0 and 104-1 on each processing module 102.

A cache-coherent interconnect 118 couples the L2 cache memories 110 (or L2 caches 110, for short) on the processing modules 102 to a level 3 (L3) cache memory 112. The L3 cache 112 includes L3 memory arrays 114 to store information (e.g., data and instructions) cached in the L3 cache 112. Associated with the L3 cache 112 is an L3 cache controller (L3 Ctrl) 116. (The L1 caches 106 and 108 and L2 caches 110 also include memory arrays and have associated cache controllers, which are not shown in FIG. 1 for simplicity.)

In the example of FIG. 1, the L3 cache 112 is the highest-level cache memory in the memory system 100 and is therefore referred to as the last-level cache (LLC). In other examples, a memory system may include an LLC above the L3 cache 112. In some embodiments, the L1 caches 106 and 108, L2 caches 110, and L3 cache 112 are implemented using static random-access memory (SRAM).

In addition to coupling the L2 caches 110 to the L3 cache 112, the cache-coherent interconnect 118 maintains cache coherency throughout the system 100. The cache-coherent interconnect 118 is also coupled to main memory 124 through memory interfaces 122. In some embodiments, the main memory 124 is implemented using dynamic random-access memory (DRAM). In some embodiments, the memory interfaces 122 coupling the cache-coherent interconnect 118 to the main memory 124 are double-data-rate (DDR) interfaces.

The cache-coherent interconnect 118 is also connected to input/output (I/O) interfaces 128, which allow the cache-coherent interconnect 118, and through it the processing modules 102, to be coupled to peripheral devices. The I/O interfaces 128 may include interfaces to a hard-disk drive (HDD) or solid-state drive (SSD) 126. An SSD 126 may be implemented using Flash memory or other nonvolatile solid-state memory. The HDD/SDD 126 may store one or more applications 130 for execution by the processor cores 104-0 and 104-1.

In some embodiments, the cache-coherent interconnect 118 includes a prefetcher 120 that monitors a stream of memory requests, identifies a pattern in the stream, and based on the pattern speculatively fetches information into a specified level of cache memory (e.g., from a higher level of cache memory or from the main memory 124). In some embodiments, prefetchers may be included in one or more respective levels of cache memory (e.g., in the L1 caches 106 and/or 108, L2 caches 110, L3 cache 112, and/or memory interfaces 122), instead of or in addition to in the cache-coherent interconnect 118.

The L1 caches 106 and 108, L2 caches 110, L3 cache 112, and main memory 124 (and in some embodiments, the HDD/SSD 126) form a memory hierarchy in the memory system 100. Each level of this hierarchy has less storage capacity but faster access time than the level above it: the L1 caches 106 and 108 offer less storage but faster access than the L2 caches 110, which offer less storage but faster access than the L3 cache 112, which offers less storage but faster access than the main memory 124.

The memory system 100 is merely an example of a multi-level memory system configuration; other configurations are possible.

An application 130 (e.g., a cloud-based application) executed by the processor modules 102 may include information (e.g., instructions and/or a first portion of data) that is commonly referenced (and thus commonly accessed) and information (e.g., a second portion of data) that is referenced (and thus accessed) infrequently or only once. For example, a cloud-based application 130 may have an instruction working set of approximately 2 megabytes (MB), one to two MB of commonly referenced operating system (OS) and/or application data, and a data set of multiple gigabytes (GB). The instruction working set and commonly referenced data have relatively high cache hit rates, because they are commonly referenced and in some embodiments are small enough to fit in cache memory (e.g., the L1 caches 106 and 108, L2 caches 110, and/or L3 cache 112). Blocks of information in the data set as cached in respective cachelines may have high cache miss rates, however, because the application 130 has access patterns that do not return frequently to the same cachelines and because the data set may be much larger than the available cache memory (e.g., than the L1 caches 106 and 108, L2 caches 110, and/or L3 cache 112). Caching blocks from the data set may pollute the cache memory with cachelines that are unlikely to be hit on (i.e., are unlikely to produce a cache hit) and that force eviction of other cachelines that may be more likely to be hit on.

To mitigate this cache pollution, caching priority designators may be assigned to respective addresses of information (e.g., instructions and/or data) stored in the memory system 100 for a particular application 130. Cache memory management policies may be selected based on values of the caching priority designators. A block of information (e.g., a page, which in one example is 4 kB) may be aggressively cached when the caching priority designator assigned to its address (or addresses) has a first value and not when the caching priority designator assigned to its address (or addresses) has a second value.

In some embodiments, each caching priority designator is a single bit. The bit is assigned a first value (e.g., ‘1’, or alternately ‘0’) when the corresponding information has a high caching priority and a second value (e.g., ‘0’, or alternately ‘1’) when the corresponding information has a low caching priority. For example, addresses for instructions and commonly referenced data are assigned caching priority designators of the first value and addresses for infrequently referenced data are assigned caching priority designators of the second value.

In some embodiments, each caching priority designator includes two bits. The first bit indicates whether the corresponding information is instructions or data. The second bit indicates, for data, whether the data is commonly referenced or infrequently referenced. Setting the first bit to indicate that the information is instructions specifies a high caching priority. Setting the first bit to indicate that the information is data and the second bit to indicate that the data is commonly referenced also specifies a high caching priority. Setting the first bit to indicate that the information is data and the second bit to indicate that the data is infrequently referenced specifies a low caching priority.

Examples of cache memory management policies that may be selected based on values of the caching priority designators include write-back policies, eviction policies, and prefetching policies. In some embodiments, for write-back, the level in the memory hierarchy to which a cacheline is to be written back upon eviction is selected based on its caching priority designator. For example, a cacheline may be written back to the next highest level of cache memory (e.g., from an L1 cache 106 or 108 to the L2 cache 110 in the same processing module 102, or from an L2 cache 110 to L3 cache 112) when its caching priority designator indicates a high caching priority and may be written back to main memory 124 when its caching priority designator indicates a low caching priority. Writing information with a low caching priority back to main memory 124 instead of a higher level of cache memory avoids polluting the higher level of cache memory with information that is unlikely to be hit on.

In some embodiments, a cacheline is selected for eviction based at least in part on its caching priority designator. For example, a cacheline storing information with a caching priority designator that indicates a low caching priority is selected for eviction over another cacheline that stores information with a caching priority designator that indicates a high caching priority. The former cacheline is less likely to be hit on than the later cacheline, as indicated by the caching priority designators, and is therefore the better choice for eviction. Cacheline eviction is performed to make room in a level of cache memory (e.g., L1 cache 106 or 108, L2 cache 110, or L3 cache 112) for installing a new cacheline.

In some embodiments, a decision as to whether to prefetch (e.g., speculatively fetch) a block of information into a particular level of cache memory is based at least in part on the corresponding caching priority designator. For example, the block of information may be speculatively fetched if the corresponding caching priority designator indicates a high caching priority, but not if the corresponding caching priority designator indicates a low caching priority. In some embodiments, one or more lower levels of cache memory (e.g., L1 caches 106 and/or 108) perform prefetching regardless of the caching priority designator values, but one or more higher levels of cache memory (e.g., L2 cache 110 and/or L3 cache 112) only prefetch information for which the corresponding caching priority designator values indicate a high caching priority.

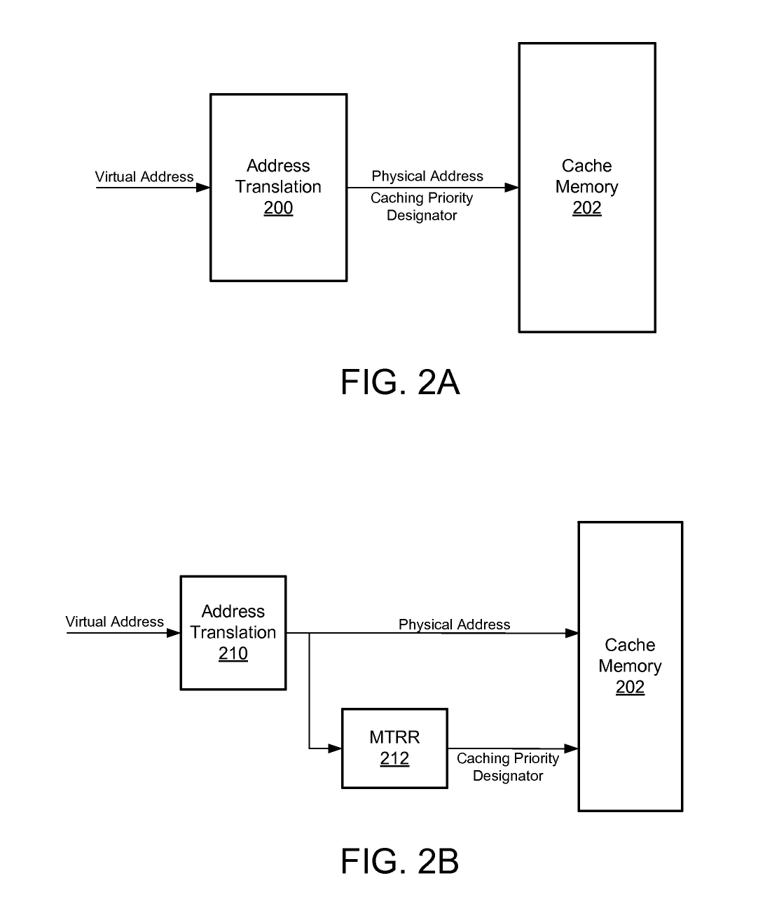

Caching priority designators may be assigned using address translation. FIG. 2A is a block diagram showing address translation 200 (e.g., implemented in a processor core 104-0 or 104-1, FIG. 1) coupled to a cache memory 202 (e.g., L1-I$ 106 or L1-D$ 108, FIG. 1) in accordance with some embodiments. In some embodiments, address translation 200 is implemented using page translation tables, which may be hierarchically arranged. A virtual address (or portion thereof) specified in a memory access request (e.g., a read request or write request) is provided to the address translation 200, which maps the virtual address to a physical address and assigns a corresponding caching priority designator. The physical address and caching priority designator are provided to the cache memory 202 along with a command (not shown) corresponding to the request.

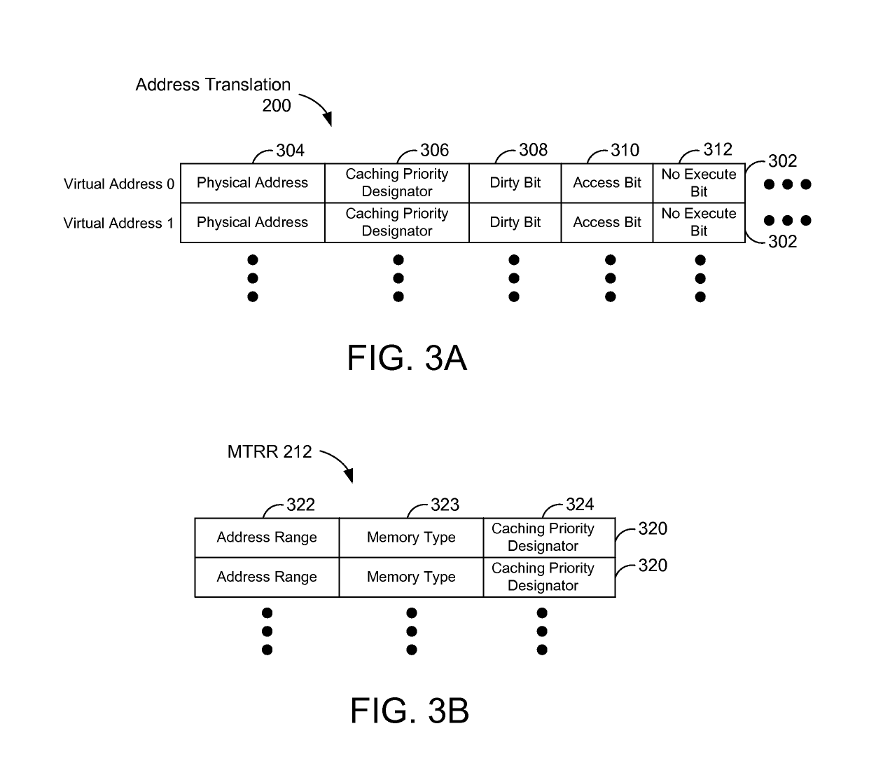

FIG. 3A shows a data structure for the address translation 200 (FIG. 2A) in accordance with some embodiments. The address translation 200 includes a plurality of rows 302, each corresponding to a distinct virtual address. The virtual addresses index the rows 302. For example, a first row 302 corresponds to a first virtual address (“virtual address 0”) and a second row 302 corresponds to a second virtual address (“virtual address 1”). Each row 302 includes a physical address field 304 to store a physical address that maps to the row's virtual address and a caching priority designator field 306 to store the caching priority designator assigned to the row's virtual address, and thus to the physical address in the field 304. Each row 302 may also include a dirty bit field 308 to indicate whether the page containing the physical address has been written to, an access bit field 310 to indicate whether the page containing the physical address has been accessed, and a no-execute bit field 312 to store a no-execute bit to indicate whether information in the page containing the physical address may be executed (e.g., includes instructions). The address translation 200 may include additional fields (not shown). For example, the address translation 200 may include a field for bits reserved for use by the operating system. In some embodiments, one or more of the bits reserved for use by the operating system may be used for the caching priority designator, instead of specifying the caching priority designator in a distinct field 306. When a virtual address is provided to the address translation 200, the row 302 indexed by the virtual address is read and the information from the fields 304, 306, 308, 310, 312, and/or any additional fields is provided to the cache memory 202 (FIG. 2A).

While the data structure for the address translation 200 is shown in FIG. 3A as a single table for purposes of illustration, it may be implemented using a plurality of hierarchically arranged page translation tables. For example, virtual addresses are divided into multiple portions. Entries in a page-map level-four table, as indexed by a first virtual address portion, point to respective page-directory pointer tables (e.g., level-three tables), which are indexed by a second virtual address portion. Entries in the page-directory pointer tables point to respective page-directory tables (e.g., level-two tables), which are indexed by a third virtual address portion. Entries in the page-directory tables point to respective page tables (e.g., level-one tables), which are indexed by fourth virtual address portions. Entries in the page tables point to respective pages, which are divided into physical addresses indexed by a fifth virtual address portion. The page tables entries (or alternatively, entries in tables in another layer of the hierarchy) may specify the caching priority designator as well as other bits associated with respective pages. In some embodiments, one or more levels of this hierarchy are omitted. For example, the page tables are omitted and the page-directory table entries provide the caching priority designators for addresses spanning some multiple of the page size. In another example, the page tables and page-directory tables are omitted and the page-directory pointer table entries provide the caching priority designators for addresses spanning some (even larger) multiple of the page size. The number of levels in the hierarchy of page translation tables may depend on the page size, which may be variable.

Caching priority designators may also be assigned using memory-type range registers (MTRRs). FIG. 2B is a block diagram showing address translation 210 and an MTRR 212 coupled to a cache memory 202 (e.g., L1-I$ 106 or L1-D$ 108, FIG. 1) in accordance with some embodiments. The address translation 210 and MTRR 212 are both implemented, for example, in a processor core 104-0 or 104-1 (FIG. 1). A virtual address (or portion thereof) specified in a memory access request (e.g., a read request or write request) is provided to the address translation 210. The address translation 210 maps the virtual address to a physical address and provides the physical address to the cache memory 202 and to the MTRR 212. (The address translation 210 may also provide corresponding attributes, such as a dirty bit, access bit, and/or no-execute bit, to the cache memory 202.) The MTRR 212 identifies a range of physical addresses that includes the specified physical address and determines a corresponding caching priority designator, which is provided to the cache memory 202.

FIG. 3B shows a data structure for the MTRR 212 (FIG. 2B) in accordance with some embodiments. The MTRR 212 includes a plurality of entries 320, each of which includes a field 322 specifying a range of addresses (e.g., with a range size that is a power of two), a field 323 specifying a memory type and corresponding caching policy (e.g., uncacheable, write-combining, write-through, write-protect, or write-back) for the range of addresses, and a field 324 specifying a caching priority designator for the range of addresses. Every address in the range specified in a field 322 for an entry 320 thus is assigned the caching priority designator specified in the corresponding field 324. Alternatively, the field 324 is omitted and the memory type specified in the field 323 determines the caching priority designator. For example, the available memory types may include high-priority write-back, which corresponds to a caching priority designator indicating a high caching priority, and low-priority write-back, which corresponds to a caching priority designator indicating a low caching priority.

In some embodiments, the caching priority assignments in the address translation 200 (FIGS. 2A and 3A) or the MTRR 212 (FIGS. 2B and 3B) are generated in software. For example, the HDD/SSD 126 (FIG. 1) includes a non-transitory computer-readable storage medium, and the application 130 (FIG. 1) includes instructions stored on the non-transitory computer-readable storage medium that, when executed by one or more of the processor cores 104-0 and 104-1 (FIG. 1), result in the assignment of caching priority designators to respective addresses in the address translation 200 (FIGS. 2A and 3A) or the MTRR 212 (FIGS. 2B and 3B). For example, the instructions include instructions to generate and/or modify the address translation 200 (FIGS. 2A and 3A) or the MTRR 212 (FIGS. 2B and 3B). In some embodiments, the operating system is configured to provide the application 130 (FIG. 1) with a mechanism to configure the address translation 200 (FIGS. 2A and 3A) or the MTRR 212 (FIGS. 2B and 3B) with the desired caching priority designators.

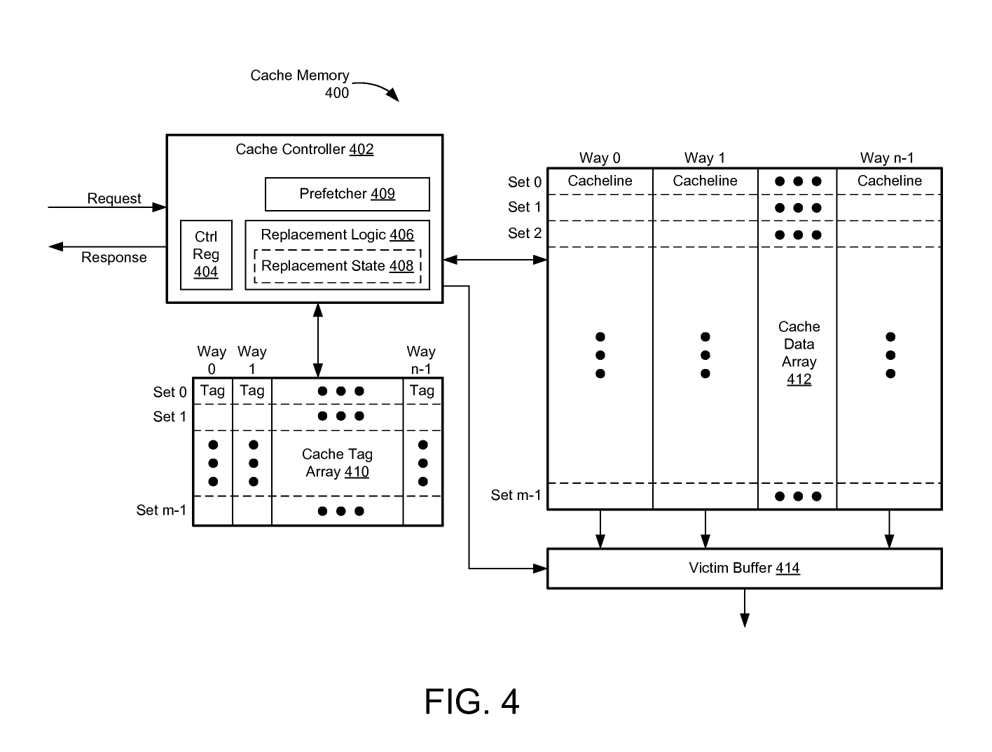

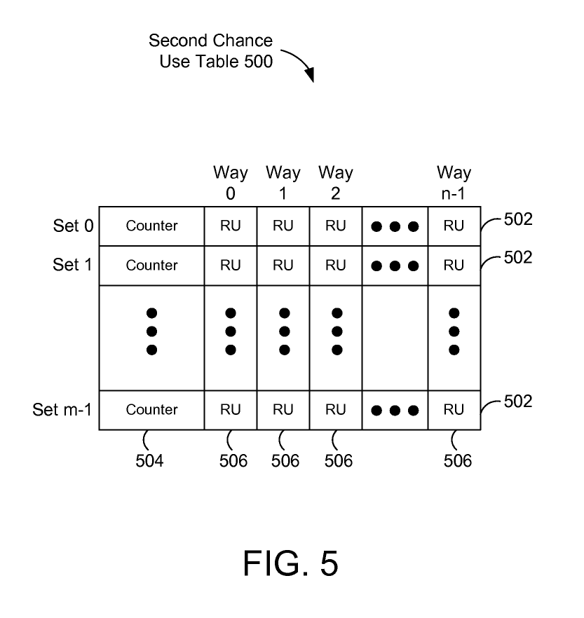

FIG. 4 is a block diagram of a cache memory (and associated cache controller) 400 in accordance with some embodiments. The cache memory 400 is a particular level of cache memory (e.g., an L1 cache 106 or 108, an L2 cache 110, or the L3 cache 112, FIG. 1) in the memory system 100 (FIG. 1) and may be an example of cache memory 202 (FIGS. 2A-2B). The cache memory 400 includes a cache data array 412 and a cache tag array 410. (The term data as used in the context of the cache data array 412 may include instructions as well as data to be referenced when executing instructions.) A cache controller 402 is coupled to the cache data array 412 and cache tag array 410 to control operation of the cache data array 412 and cache tag array 410. In some embodiments, the caching priority designators may be stored in the cache data array 412, cache tag array 410, or replacement state 408.

Addresses for information cached in respective cachelines in the cache tag array 410 are divided into multiple portions, including an index and a tag. Physical addresses are typically stored, but some embodiments may store virtual addresses. Cachelines are installed in the cache data array 412 at locations indexed by the index portions of the corresponding addresses, and tags are stored in the tag memory array 412 at locations indexed by the index portions of the corresponding addresses. (A cacheline may correspond to a plurality of virtual addresses that share common index and tag portions and also may be assigned the same caching priority designator.) To perform a memory access operation in the cache memory 400, a memory access request is provided to the cache controller 402 (e.g., from a processor core 104-0 or 104-1, FIG. 1). The memory access request specifies an address. If a tag stored at a location in the cache tag array 410 indexed by the index portion of the specified address matches the tag portion of the specified address, then a cache hit occurs and the cacheline at a corresponding location in the cache data array 412 is returned in response to the request. Otherwise, a cache miss occurs.

In the example of FIG. 4, the cache data array 412 is set-associative: for each index, it includes a set of n locations at which a particular cacheline may be installed, where n is an integer greater than one. The cache data array 412 is thus divided into n ways, numbered 0 to n−1; each location in a given set is situated in a distinct way. In one example, n is 16. The cache data array 412 includes m sets, numbered 0 to m−1, where m is an integer greater than one. The sets are indexed by the index portions of addresses. The cache tag array 410 is similarly divided into sets and ways.

While FIG. 4 shows a set-associative cache data array 412, the cache data array 412 may instead be direct-mapped. A direct-mapped cache effectively only has a single way.

A new cacheline to be installed in the cache data array 412 thus may be installed in any way of the set specified by the index portion of the addresses corresponding to the cacheline. If all of the ways in the specified set already have valid cachelines, then a cacheline may be evicted from one of the ways and the new cacheline installed in its place. The evicted cacheline is placed in a victim buffer 414, from where it is written back to a higher level of memory in the memory system 100 (FIG. 1). In some embodiments, the higher level of memory to which the evicted cacheline is written back is determined based on the caching priority designator for the cacheline (e.g., as assigned to the addresses corresponding to the cacheline). For example, if the caching priority designator has a first value indicating a high caching priority, the cacheline is written back to the next highest level of cache memory. If the cache memory 400 is an L1 cache 106 or 108, the cacheline is written back to the L2 cache 110 on the same processing module 102 (FIG. 1). If the cache memory 400 is an L2 cache 110, the cacheline is written back to the L3 cache 112 (FIG. 1). If the caching priority designator has a second value indicating a low caching priority, however, then the cacheline is written back to main memory 124 (FIG. 1), and is no longer stored in any level of cache memory after its eviction from the cache memory 400. Alternatively, the cacheline is written back to a level of cache memory above the next highest level (e.g., from an L1 cache 106 or 108 to L3 cache 112, FIG. 1) if the caching priority designator has the second value. The determination of where to write back the cacheline is made, for example, by replacement logic 406 in the cache controller 402.

Caching priority designators also may be used to identify the cacheline within a set to be evicted. A cacheline with a low caching priority may be selected for eviction over cachelines with high caching priority. In some embodiments, eviction is based on a least-recently-used (LRU) replacement policy modified based on caching priority designators. The replacement logic 406 in the cache controller includes replacement state 408 to track the order in which cachelines in respective sets have been accessed. The replacement state 408 specifies which cacheline in each set is the least recently used. The replacement logic 406 will select the LRU cacheline in a set for eviction. The LRU specification, however, may be based on the caching priority designator as well as on actual access records. When a cacheline in a respective set is accessed, its caching priority designator is checked. If the caching priority designator has a first value indicating a high caching priority, the cacheline can be marked as more recently used than cachelines in the same set for which the caching priority designator has the second value indicating a low caching priority in the replacement state 408. This designation makes the cacheline less likely to be selected for eviction. If, however, the caching priority designator has a second value indicating a low caching priority, then the cacheline can be marked as the LRU cacheline for the set. This designation makes the cacheline more likely to be selected for eviction when one way of the set is to be evicted from the cache to make space so a new cacheline can be written into the cache.

In some embodiments, eviction is based on a second-chance replacement policy modified based on caching priority designators. Second-chance replacement policies are described in U.S. Pat. No. 7,861,041, titled “Second Chance Replacement Mechanism for a Highly Associative Cache Memory of a Processor,” issued Dec. 28, 2010, which is incorporated by reference herein in its entirety. FIG. 5 illustrates a data structure for a second chance use table 500 used to implement a second-chance replacement policy modified based on caching priority designators in accordance with some embodiments. The second-chance use table 500 is an example of an implementation of replacement state 408 (FIG. 4). Each row 502 of the second chance use table 500 corresponds to a respective set and includes a counter 504 and a plurality of bit fields 506, each of which stores a “recently used” (RU) bit for a respective way. The counter 504 counts from 0 to n−1; the value of the counter 504 at a given time points to one of the RU bit fields 506. When a cacheline in a respective set and way is accessed, its caching priority designator is checked. If the caching priority designator has a first value indicating a high caching priority, the RU bit for the cacheline is set to a first value (e.g., ‘1’, or alternately ‘0’). If the caching priority designator has a second value indicating a low caching priority, the RU bit for the cacheline is set to a second value (e.g., ‘0’, or alternately ‘1’). When the replacement logic 406 (FIG. 4) is to select a cacheline in a set for eviction, it checks the RU bit for the way to which the counter 504 points. If the RU bit has the first value (e.g., is asserted), the cacheline for this way is not selected; instead, the RU bit is reset to the second value, the counter 504 is incremented, and the RU bit for the way to which the counter 504 now points is checked. If the RU bit has the second value (e.g., is de-asserted), however, the cacheline for this way is selected for eviction. The modified second-chance replacement policy thus favors cachelines with low caching priority for eviction over cachelines with high caching priorities.

LRU and second-chance replacement policies are merely examples of cache replacement policies that may be modified based on caching priority designators. Other cache replacement policies may be similarly modified in accordance with caching priority designators.

In some embodiments, the cache controller 402 may elect not to evict a cacheline and install a new cacheline, based on caching priority indicators. For example, if all cachelines in a set are valid and have high caching priority as indicated by their caching priority indicators, and if the new cacheline has a low caching priority as indicated by its caching priority indicator, then no cacheline is evicted and the new cacheline is not installed.

In some embodiments, the cache controller 402 includes a prefetcher 409 to speculatively fetch cachelines from a higher level of memory and install them in the cache data array 412. The prefetcher 409 monitors requests received by the cache controller 402, identifies patterns in the requests, and performs speculative fetching based on the patterns. In some embodiments, the prefetcher 409 will speculatively fetch a cacheline if a caching priority indicator associated with the cacheline has a first value indicating a high caching priority, but not if the caching priority indicator associated with the cacheline has a second value indicating a low caching priority.

In some embodiments, the cache controller 402 includes a control register 404 to selectively enable or disable use of caching priority designators. For example, caching priority designators are used in decisions regarding eviction, write-back, and/or prefetching if a first value is stored in a bit field of the control register 404. If a second value is stored in the bit field, however, the caching priority designators are ignored.

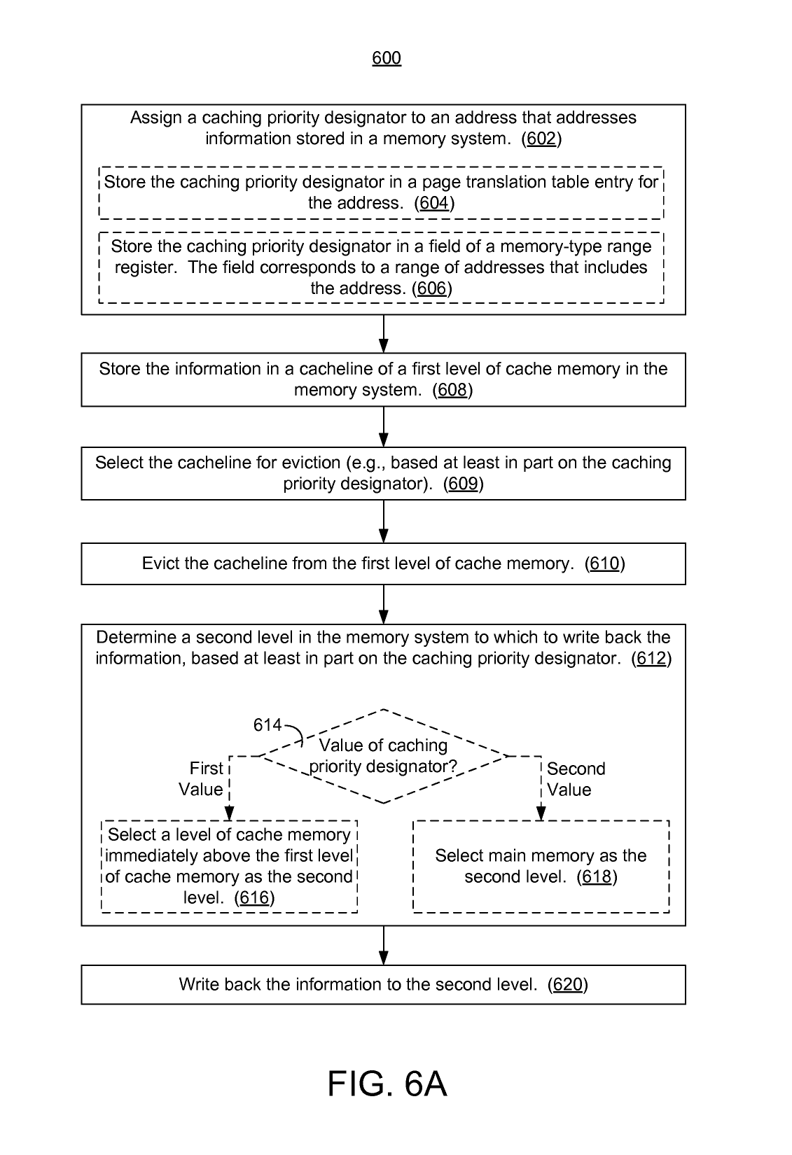

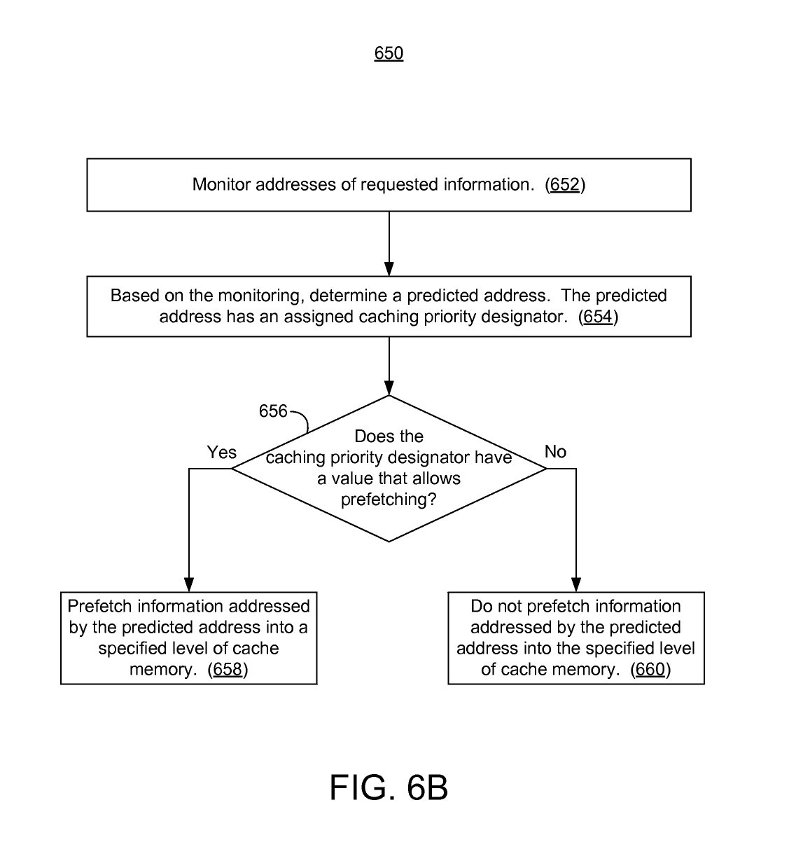

FIG. 6A is a flowchart showing a method 600 of managing cache memory in accordance with some embodiments. The method 600 may be performed in the memory system 100 (FIG. 1). For example, the method 600 is performed in a cache memory 400 (FIG. 4) that constitutes a level of cache memory in the memory system 100.

A caching priority designator is assigned (602) to an address (e.g., a physical address) that addresses information stored in a memory system. In some embodiments, the caching priority designator is assigned using address translation 200 (FIGS. 2A & 3A): the caching priority designator is stored (604) in a page translation table entry (e.g., in a field 306 of a row 302, FIG. 3A) for the address. In some embodiments, the caching priority designator is assigned using an MTRR 212 (FIGS. 2B & 3B): the caching priority designator is stored (606) in a field 324 (FIG. 3B) of the MTRR 212. The field 324 corresponds to a range of addresses (e.g., as specified in an associated field 322, FIG. 3B) that includes the address.

The information is stored (608) in a cacheline of a first level of cache memory in the memory system. For example, the information is stored in an L1 instruction cache 106, an L1 data cache 108, or an L2 cache 110 (FIG. 1). The operation 608 thus may install or modify a cacheline in the first level of cache memory.

The cacheline is selected (609) for eviction. In some embodiments, the cacheline is selected for eviction based at least in part on the caching priority designator. For example, the cacheline is selected for eviction using an LRU replacement policy or second-chance replacement policy modified to account for caching priority designators.

In some embodiments, the cacheline is selected based on an LRU replacement policy as modified based on caching priority designators. For example, the cacheline is a first cacheline in a set of cachelines. Before the first cacheline is selected (609) for eviction, a respective cacheline of the set of cachelines is accessed. In response, the respective cacheline is specified as the most recently used cacheline of the set if a corresponding caching priority designator has a first value (e.g., a value indicating a high caching priority) and is specified as the least recently used cacheline of the set if the corresponding caching priority designator has a second value (e.g., a value indicating a low caching priority). Specification of the respective cacheline as MRU or LRU is performed in the replacement state 408 (FIG. 4).

In some embodiments, the cacheline is selected based on a second-chance replacement policy as modified based on caching priority designators. The second-chance replacement policy uses bits (e.g., RU bits in bit fields 506, FIG. 5) that indicate whether cachelines in a set have been accessed since previously being considered for eviction. For example, the cacheline is a first cacheline in a set of cachelines. Before the first cacheline is selected (609) for eviction, a respective cacheline of the set of cachelines is accessed. In response, an RU bit for the respective cacheline is asserted (e.g., set to a first value) when a caching priority designator corresponding to the respective cacheline has a first value (e.g., a value indicating a high caching priority) and is de-asserted (e.g., set to a second value) when the caching priority designator corresponding to the respective cacheline has a second value (e.g., a value indicating a low caching priority).

The cacheline is evicted (610) from the first level of cache memory. A second level in the memory system to which to write back the information is determined (612), based at least in part on the caching priority designator. In some embodiments, the replacement logic 406 (FIG. 4) makes the determination 612 by selecting between two levels of memory in the memory system 100 (FIG. 1) based on a value of the caching priority designator.

For example, the value of the caching priority designator is checked (614). If the caching priority designator has a first value (e.g., a value indicating a high caching priority), then a level of cache memory immediately above the first level of cache memory is selected (616) as the second level. If the first level is an L1 cache 106 or 108, the corresponding L2 cache 110 (FIG. 1) is selected. If the first level is an L2 cache 110, the L3 cache 112 is selected. If, however, the caching priority designator has a second value, then the main memory 124 is selected (618) as the second level.

The information (e.g., the cacheline containing the information) is written back (620) to the second level.

The method 600 allows commonly referenced information (e.g., instructions and/or commonly referenced data) to be maintained in a higher level of cache upon eviction, while avoiding cache pollution by not maintaining infrequently referenced information (e.g., a multi-gigabyte working set of data) in the higher level of cache. The method 600 also allows infrequently referenced information to be prioritized for eviction over commonly referenced data, thus improving cache performance.

FIG. 6B is a flowchart showing a method 650 of managing cache memory in accordance with some embodiments. The method 650 may be performed in the memory system 100 (FIG. 1). For example, the method 650 may be performed by the prefetcher 120 (FIG. 1) or the prefetcher 409 (FIG. 4).

Addresses of requested information are monitored (652). For example, physical addresses specified in requests provided to the cache controller 402 (FIG. 4) are monitored. Alternatively, corresponding virtual addresses are monitored.

A predicted address is determined (654) based on the monitoring. The predicted address has an assigned caching priority designator (e.g., assigned using address translation 200, FIGS. 2A and 3A, or MTRR 212, FIGS. 2B and 3B).

A determination is made (656) as to whether the assigned caching priority designator has a value that allows prefetching. For example, a first value of the caching priority designator (e.g., a value indicating a high caching priority) may allow prefetching and a second value of the caching priority designator (e.g., a value indicating a low caching priority) may not allow prefetching.

If the value allows prefetching (656-Yes), information addressed by the predicted address is prefetched (658) into a specified level of cache memory (e.g., into an L1 cache 106 or 108, an L2 cache 110, or the L3 cache 112). If the value does not allow prefetching (656-No), the information addressed by the predicted address is not prefetched (660) into a specified level of cache memory.

The method 650 thus allows selective prefetching based on caching priority. Not prefetching information with a low caching priority avoids polluting cache memory with cachelines that are unlikely to be hit on.

While the methods 600 and 650 include a number of operations that appear to occur in a specific order, it should be apparent that the methods 600 and 650 can include more or fewer operations, which can be executed serially or in parallel. An order of two or more operations may be changed, performance of two or more operations may overlap, and two or more operations may be combined into a single operation. For example, the operations 612 (including operations 614, 616, and 618) and/or 620 (FIG. 6A) may be omitted from the method 600. Alternatively, the operations 612 and 620 are included in the method 600, and the operation 609 is not performed based on the caching priority designator. Furthermore, the methods 600 and 650 may be combined into a single method.

The foregoing description, for purpose of explanation, has been described with reference to specific embodiments. However, the illustrative discussions above are not intended to be exhaustive or to limit all embodiments to the precise forms disclosed. Many modifications and variations are possible in view of the above teachings. The disclosed embodiments were chosen and described to best explain the underlying principles and their practical applications, to thereby enable others skilled in the art to best implement various embodiments with various modifications as are suited to the particular use contemplated.

What is claimed is:

1. A method of managing cache memory, comprising:
assigning a caching priority designator to an address that addresses information stored in a memory system;
storing the information in a cacheline of a first level of cache memory in the memory system;
evicting the cacheline from the first level of cache memory;
determining a second level in the memory system to which to write back the information, based at least in part on the caching priority designator; and
writing back the information to the second level.

2. The method of claim 1, wherein:
the address is a virtual address; and
assigning the caching priority designator comprises storing the caching priority designator in a page translation table.

3. The method of claim 1, wherein:
the address is included within a range of addresses; and
assigning the caching priority designator comprises storing the caching priority designator in a field of a memory-type range register, wherein the field corresponds to the range of addresses.

4. The method of claim 1, wherein:
the memory system comprises main memory and multiple levels of cache memory; and
determining the second level comprises:
selecting a level of cache memory immediately above the first level of cache memory as the second level when the caching priority designator has a first value; and
selecting main memory as the second level when the caching priority designator has a second value.

5. The method of claim 4, wherein the first level of cache memory is selected from the group consisting of an L1 cache and an L2 cache.

6. The method of claim 1, further comprising selecting the cacheline for eviction based at least in part on the caching priority designator.

7. The method of claim 6, wherein:
the cacheline is a first cacheline of a set of cachelines;
the selecting is performed in accordance with a least-recently-used (LRU) policy; and
the method further comprises, before the selecting:
accessing respective cachelines of the set of cachelines;
specifying an accessed cacheline as most recently used when a corresponding caching priority designator has a first value; and
specifying an accessed cacheline as least recently used when a corresponding caching priority designator has a second value.

8. The method of claim 6, wherein:
the cacheline is a first cacheline of a set of cachelines;
the selecting is performed in accordance with bits indicating whether cachelines of the set have been accessed since previously being considered for eviction; and
the method further comprises, before the selecting:
accessing respective cachelines of the set of cachelines;
asserting a bit for an accessed cacheline when a corresponding caching priority designator has a first value; and
de-asserting a bit for an accessed cacheline when a corresponding caching priority designator has a second value.

9. The method of claim 1, further comprising:
monitoring addresses of requested information;
based on the monitoring, determining a predicted address, wherein the predicted address is assigned a corresponding caching priority designator;
verifying that the corresponding caching priority designator has a value that allows prefetching; and
in response to the verifying, prefetching information addressed by the predicted address into a specified level of cache memory.

10. The method of claim 1, wherein the caching priority designator comprises a first bit to indicate whether the information comprises data or instructions.

11. The method of claim 1, wherein the caching priority designator further comprises a second bit to indicate, for information that comprises data, a caching priority of the data.

12. A circuit, comprising:
multiple levels of cache memory, including a first level of cache memory;
an interconnect to couple to a main memory, wherein the main memory and the multiple levels of cache memory are to compose a plurality of levels of a memory system; and
a cache controller to evict a cacheline from the first level of cache memory and to determine a second level of the plurality of levels to which to write back information stored in the evicted cacheline based at least in part on a caching priority designator assigned to an address of the information.

13. The circuit of claim 12, further comprising a page translation table to assign the caching priority designator to the address.

14. The circuit of claim 12, further comprising a memory-type range register to assign the caching priority designator to a range of addresses that includes the address.

15. The circuit of claim 12, wherein:
the first level of cache memory is an L1 cache;
the multiple levels of cache memory further comprise an L2 cache; and
the cache controller is to determine the second level by selecting the L2 cache when the caching priority designator has a first value and selecting the main memory when the caching priority designator has a second value.

16. The circuit of claim 12, wherein:
the first level of cache memory is an L2 cache;
the multiple levels of cache memory further comprise an L1 cache and an L3 cache; and
the cache controller is to determine the second level by selecting the L3 cache when the caching priority designator has a first value and selecting the main memory when the caching priority designator has a second value.

17. The circuit of claim 12, wherein the cache controller comprises replacement logic to select the cacheline for eviction based at least in part on the caching priority designator.

18. The circuit of claim 12, further comprising a prefetcher to speculatively fetch blocks of information into a specified level of cache memory based at least in part on values of caching priority designators assigned to addresses of the blocks of information.

19. The circuit of claim 12, wherein the cache controller comprises a register to selectively enable or disable use of the caching priority designator.

20. A non-transitory computer-readable storage medium storing instructions, which when executed by one or more processor cores, cause the one or more processor cores to assign a caching priority designator to an address that addresses information stored in memory;
wherein a first level of cache memory, when evicting a cacheline storing the information, is to determine a second level of memory to which to write back the information based at least in part on the caching priority designator.
